(19) United States
(12) Patent Application Publication
(10) Pub. No.: US 2004/0190920 A1
(43) Pub. Date: Sep. 30, 2004

(54) Process and mechanism for scanning a register mark

(76) Inventors: Christian Friedrich Engeln, Kronshagen (DE); Rolf Johannes Spilz, Gettorf (DE)

Correspondence Address: Lawrence P. Kessler, Patent Department, NexPress Solutions LLC, 1447 St. Paul Street, Rochester, NY, 14653-7103, US

(21) Appl. No.: 10/774,959

(22) Filed: Feb. 9, 2004

(30) Foreign Application Priority Data
Feb. 17, 2003 (DE) 103 06 442.7

(51) Int. Cl. G03G 15/00; G03G 15/01

(52) U.S. Cl. 399/49; 399/301; 347/116

(57) ABSTRACT

A process and mechanism to scan at least one register mark on a printing medium in a printing machine, whereby at least one register mark is imprinted on the first form side of the printing medium and the register mark is scanned by an initial sensor, whereby when the printing medium is inverted, the register mark on the first form side is scanned, and the register mark on the reverse side is ascertained using the register mark on the first form side.

### FIELD OF THE INVENTION

The invention concerns a process and mechanism for scanning a register mark on a print medium in a printing machine.

### BACKGROUND OF THE INVENTION

In the printing industry, many printed themes or imprinted images are applied to various substrates or printing media, typically on paper, in various styles and designs. The proper physical location of the imprinted images on the printing medium is extremely important for the quality of the printing. Just as important is the proper location of the individual color applications that blend together in a single printed color image. Marks are used in the printing industry in order to achieve a properly located imprint; these marks are usually imprinted onto the printing medium and used as a means of comparison to detect possible shifting of the imprinted image from the desired position. The marks also serve to determine the location of the printing medium on the conveying mechanism and to detect the possible shifting of the position of the printing medium on the conveying mechanism. These marks are referred to as register marks and in color printing, also as compasses.

The register marks are measured and the results of the measurement are used to determine whether the imprint is properly positioned, whether the printing medium is properly positioned on the conveying mechanism and/or how great the deviations are in each case. Shifting of the position of the imprinted image or the printing medium on the conveying mechanism that is determined in this way can then be appropriately corrected. In the case of multi-colored printing, in which color layers or color applications are printed on top of one another, register marks are used for each individual color application. In the case of duplex printing, printing on both sides of the printing media, i.e., the first form side and the second side, prior art reveals register marks being imprinted on the first form side, as well as the second side, which are scanned independently of one another. The disadvantage here is that both sides of the printing medium are provided with register marks, in that the printing medium is fed into a printing mechanism after being inverted, in which then an additional register mark is imprinted on the second side.

### SUMMARY OF THE INVENTION

The objective of the invention is to determine incorrect positioning of a printing medium or an imprinted image on a printing medium in a simple way when both sides of the medium are printed.

Provision is made for a process for scanning at least one register mark on a printing medium in a printing machine whereby at least one register mark is imprinted on the first form side of the printing medium and this register mark is scanned by an initial sensor, after which the printing medium is inverted and the register mark on the first form side is scanned and, using, the register mark on the first form side a determination is made as to whether the second side is in register. In addition, a mechanism is made available for scanning at least one register mark on a printing medium in a printing machine whereby at least one register mark is on the first form side and an initial sensor is available for scanning the register mark on the first form side before the printing medium is inverted and to again scan the register mark through the printing medium after the printing medium has been inverted.

In one embodiment, the register mark on the first form side is scanned by a second sensor that is located on the opposite side of the printing medium relative to the initial sensor.

In yet another embodiment of the invention, the register mark on the first form side is scanned through the printing medium by the initial sensor. The result is that only one sensor is required.

In a beneficial embodiment, the register mark has a triangular shape and shifting of the printing medium at a right angle to the direction of travel of the printing medium can be detected.

### BRIEF DESCRIPTION OF THE DRAWINGS

Embodiments of the invention are described in detail by the use of figures as follows:

FIG. 1 shows a sensor and a schematic overhead view of the first form side of a printing medium that bears a register mark and is located on a section of a conveyor belt of a printing machine;

FIG. 2 shows a schematic bottom view of the first form side, after the printing medium 3 as shown in FIG. 1 has been inverted, and a second sensor that scans the register mark through a conveyor belt; and

FIG. 3 shows a schematic overhead view of the second side as shown in FIG. 1 with the initial sensor that scans the register mark through the printing medium.

### DETAILED DESCRIPTION OF THE INVENTION

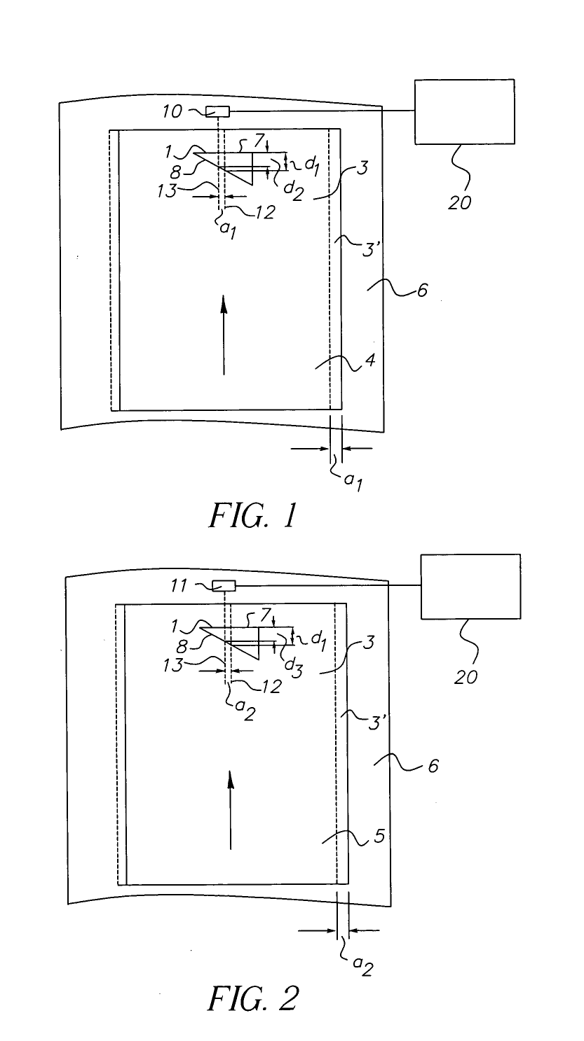

FIG. 1 shows a schematic overhead view of the first form side 4 of a printing medium 3, which is being moved through a printing machine on a conveyor belt 6, of which one section is shown. The conveyor belt 6 is moving in the direction shown by the arrow. A register mark 1 is imprinted on the printing medium 3, the express purpose of which is to determine any shifting of the printing medium 3 on the conveyor belt 6. In the present embodiment, the register mark 1 has a triangular shape that is, in particular, a right triangle, whereby the catheti of the triangle run parallel to the edges of the printing medium. With the aid of the triangular register mark 1 it is possible, in particular, to ascertain any shifting of the printing medium 3 on the conveyor belt 6 at a right angle to the direction of travel of the printing medium 3, the cross track. A shifting of the printing material 3 at a right angle to the direction of travel of the conveyor band 6 can be ascertained in that both the leading edge 7 of the register mark 1 and the trailing edge 8 of the register mark 1 are scanned relative to the direction of travel of the printing medium 3. The difference between these two values of the register mark 1 that have been scanned is the actual value, which is then compared with the set value. In this process, the set value is stored in a control mechanism 20 and is compared therein with the actual value. From the comparison of the actual value and the set value a possible shifting of the printing medium 3 in relation to the conveyor belt 6 can be ascertained to exist, if the actual value is not the same as the set value. If, for example, the printing medium 3 is shifted to the right as shown in FIG. 1, then the difference in value calculated from the scanned leading edge 7 and the scanned trailing edge 8 of the register mark 1, the actual value, is smaller than the set value, because the triangular register mark 1 is shifted such that the distance from the leading edge 7 to the trailing edge 8 of the register mark 1 is decreased. The greater the shifting of the register mark 1 on the printing medium 3 in relation to its correct position, the greater is the difference between the actual value and the set value. From the difference found in the control mechanism 20 between the actual value and the set value the extent of the shifting of the register mark 1 can be clearly ascertained.

In this way, both a shifting of the register mark 1 in relation to the printing medium 3 and a shifting of the printing medium 3 in relation to the conveyor belt 6 can be ascertained. In the first case the presumption is that the printing medium 3 is located in its correct position on the conveyor belt 6. In the second case, the presumption is that the register mark 1 is itself always located in its ideal position in relation to the printing medium 3.

Specifically, the printing medium 3 in the example shown in FIG. 1 is undesirably shifted to the right by the distance a₁; the printing medium 3 that is shifted to the right of its correct position is shown by solid lines, whereas the correct position on the conveyor belt 6 of the printing medium 3 without shifting is shown in imaginary presentation by dashed lines. Additionally, the register mark 1 on the printing medium 3 is shifted to the right by the distance a₁, whereby the register mark 1 in relation to the printing medium 3 is in its correct position. When the register mark 1 is in its correct position, an initial dashed line 12 runs through the middle of the register mark 1, when the printing medium 3 is in an incorrect, shifted position a second dashed line 13 runs parallel to the initial dashed line, but shifted by the distance a₁ in relation to the middle of the register mark 1. The register mark 1 in the present example is detected at the second dashed line 13. In the case of the present example, an initial sensor 10 reads with the register mark 1 measured data at the intersections of the shifted, dashed second line 13, which are the actual values. This may be done by light/dark transitions whereby the light values of the register mark 1 differ from those of the printing medium 3. When the register mark 1 is shifted, a distance d₂ is measured on the register mark 1, which defines the distance between the leading edge 7 and the trailing edge 8 of the register mark 1 in the shifted state, and which is smaller than the distance d₁, and defines by the midpoint of the leading edge 7 the distance between the leading edge 7 and the trailing edge 8 of the register mark 1 in the un-shifted, correct state. The initial sensor 10 scans the light/dark transitions from the printing medium 3 to the register mark 1 and from the register mark 1 to the printing medium 3. The sensor signals are transmitted to the control mechanism 20. The actual values that derive from the distance d₂ are compared in the control mechanism 20 with the set values that are derived from the distance d₁. The set values are derived from the correct position of the register mark 1, identified by the intersections with the register mark of the first dashed line 12 that runs through the midpoint of the leading edge 7 of the register mark 1. The distances d₂ and d₁ are determinable in the usual way by means of sensor signals from the initial sensor 10, which initiate and stop a timing count, whereby each timing count that is counted is specifically assigned to a distance. It is presumed here that the speed of the conveyor belt 6 remains constant. If the speed of the conveyor belt is ascertained by means of an encoder, the speed of the conveyor belt 6 need not be constant. From the difference between distances d₂ and d₁, the shifting of the register mark 1 in a direction at a right angle to the direction of travel of the printing medium 3, the cross track, is ascertainable. Subsequently this shift can be corrected using various measures, whereby usually apparati grasp the printing medium 3 and in a controlled manner move it in the opposite direction of the shift at a right angle to the direction of travel of the printing medium 3 on the conveyor belt 6 so as to compensate for the shift, whereby the correct position of the printing medium 3 and, particularly, the printing medium 3 that follows, is achieved. The described process and the mechanism serve, in particular, to calibrate a printing machine before the actual printing process begins. The shiftings of the register mark 1 that have been discovered, are detected during calibration, and the printing machine is adjusted before the next printing process takes place such that the position of every printing medium is correspondingly corrected; these adjustments determine the position of the printing medium 3 on the conveyor belt 6.

FIG. 2 shows a schematic bottom view (reverse side 5) of the first form side 4 of the printing medium 3 as shown in FIG. 1, whereby the printing medium 3 contrary to the representation in FIG. 1 is fed to an inverting mechanism and is inverted around its longitudinal axis, i.e., the leading edge 7 of the printing medium 3 is identical in FIGS. 1 and 2. The conveyor belt 6 is designed to be transparent so that the printing medium 3 is visible and can be scanned from below. In this embodiment, as shown in FIG. 2, a second sensor 11 is mounted below the conveyor belt 6 and it scans the register mark 1 through the conveyor belt 6. The first dashed line 12 runs through the midpoint of the leading edge 7 of the register mark 1, the second sensor 11 scans the register mark 1 through the conveyor belt 6 at the second dashed line 13. The distance between the leading edge 7 and the trailing edge 8 of the register mark 1 in the shifted state of the printing medium 3 is designated by d₃. In the event that from the view shown in FIG. 1, before the printing medium 3 is inverted, to the view shown in FIG. 2, after the printing medium 3 has been inverted, no further shifting of the printing medium 3 on the conveyor belt 6 in the direction at a right angle to the direction of travel has taken place during the travel or the inverting process, the distance d₃ will be equal to the distance d₂. In this case the distance a₂ of the shift of the printing medium 3 at a right angle to the direction of travel, as shown in FIG. 2, will be the same as the corresponding shift shown in FIG. 1, the distance a₁. The distance d₁ between the leading edge 7 and the trailing edge 8 of the printing medium 3 seen in the direction of travel and in the middle of register mark 1 is constant in FIG. 1 as in FIG. 2. It is presumed that there is no angle shift with respect to the register mark 1. The signals from the second sensor 11, which scans the register mark 1 through conveyor belt 6, are transmitted to the control mechanism 20. The distance d₃ can be ascertained in the control mechanism 20 using the signals from the second sensor, whereby the difference between d₃ and d₁ is also calculated in the control mechanism 20, and this difference is unambiguously collated to the shift a₂ of the register mark 1 at a right angle to the direction of travel of the printing medium 3, the cross track. This calculation is executable using simple geometric concepts with the help of the lengths of the sides and the angles of the triangular register mark 1. To ascertain the shift of the register mark 1 in this direction, it is necessary that the register mark 1 on the printing medium 3 and the printing medium 3 on the conveyor belt 6 have no angle shifts, i.e., that no angle displacement of the printing medium exists, the so-called skew. In the event of an angle shift of the register mark 1, the determination of the size of the shifts of the register mark 1 at a right angle to the direction of travel will be disrupted, as can be easily understood. Using the approach shown, it can be ascertained whether the register mark 1 is in register without printing an additional register mark on the reverse side 5. In this regard the term “in register” primarily refers to the proper positioning of the register mark 1 on the printing medium 3 in relation to the conveyor belt 6. With this as a guide, possible shifts in the position of the printing medium 3 on the conveyor belt 6 can be detected. Such shifts result in the imprinted image being imprinted on the wrong place on the printing medium 3, even though the transfer of the imprinted image is properly timed by the printing machine control. In addition the term “in register” refers to the proper position of the register mark 1 in relation to the printing material 3. With this as a guide, possible shifts in the position of the register mark in relation to the printing medium 3 can be detected. This kind of shift, is caused by an incorrectly timed transfer of the imprinted image, onto the printing medium 3 by the printing mechanism. This leads to the imprinted image being printed onto the incorrect place on the printing medium 3, even though the printing medium 3 is located on the correct place on the conveyor belt 6.

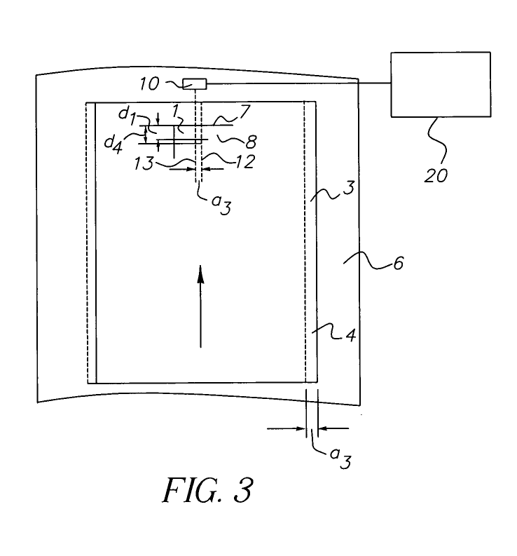

FIG. 3 shows an embodiment of the invention using a schematic overhead view of the reverse side 5 of the printing medium 3, which may be embodied in conjunction with FIG. 1. The embodiment shown in FIG. 3 is contrary to the embodiment shown in FIG. 2 and is not viewed in conjunction therewith. The printing medium 3 shown in FIG. 3 is inverted in relation to its longitudinal axis when compared with FIG. 1. The initial sensor 10 is mounted above the conveyor belt 6, is connected to the control mechanism 20, and scans the register mark 1. The register mark 1 on the first form side 4 is shown in dashed lines in an imaginary representation, because the view of the reverse side is shown, on which no register mark is imprinted. The register mark 1, on the first form side 4, which is turned toward the conveyor belt 6 and lies on the side that is turned away from the initial sensor 10; is scanned by the sensor 10 through the printing medium 3. For this purpose a commensurately sensitive initial sensor is used. Beneficially, a beam of light is directed from below the conveyor belt 6 on the side of reverse side 5, onto the conveyor belt 6 and the printing medium 3, in order to facilitate scanning the register mark 1 through the printing medium 3. The initial sensor 10 scans, in accordance with the above description, the leading edge 7 of the register mark 1, as well as its trailing edge 8, seen in the direction of travel of the conveyor belt 6, and the printing medium 3. This distance has in the middle of the register mark 1, i.e., at the midpoint of leading edge 7, a length d₁ that is constant. The corresponding distance when the printing medium 3 has shifted on the conveyor belt 6 is shown in FIG. 3 as d₄. In the event that, when compared with FIG. 1 no further shifting of the register mark 1 has occurred, the distance d₄ equals the distance d₂. In the event, however, that a shift in the position of the printing medium 3 has occurred during its travel or in the course of being inverted, the distance d₄ that is detected by the initial sensor 10 through the printing medium 3 is changed by the extent of this shift in comparison with the distance d₂, so that d₄ does not equal d₂. The initial sensor 10 transmits the sensor signals to the control mechanism 20, in which the distance d₄ is calculated from the signals as described above. The present variant to the invention is beneficial mainly because this variant calls for only the initial sensor 10 so that the second sensor 11 can be dispensed with. In this embodiment of the invention, as in the embodiment shown in FIG. 2, only one register mark 1 is required, which is here imprinted on the first form side 4 of the printing medium 3. Although only the scanning of register mark 1, for the purpose of ascertaining incorrect positioning of the register mark 1 at right angles to the direction of travel of the printing medium 3, was described above, the invention is not limited to this application. It is possible to design additional ways of ascertaining the shifting of the register mark 1 in its direction of travel, in that, for example, the initial sensor 10 scans the leading edge of the printing medium 3 and the leading edge 7 of the register mark 1 and, in this way, ascertains the distance between these, from which possibly incorrect positioning between the leading edge of the printing medium 3 and the leading edge of the register mark 1 can also be ascertained. In order to ascertain a shift in the position of the printing medium 3 in its direction of travel in relation to the conveyor belt 6, the leading edge 7 of the register mark 1 is scanned, whereby the position of the register mark 1 in relation to the printing medium 3 is correct and a correct position of the register mark 1 on the printing medium 3 is known to exist.

The invention has been described in detail with particular reference to certain preferred embodiments thereof, but it will be understood that variations and modifications can be effected within the spirit and scope of the invention.

What is claimed is:

1. Process for scanning at least one register mark (1) on a printing medium (3) in a printing machine, whereby at least one register mark (1) is imprinted on the first form side (4) of the printing medium (3) and the register mark (1) is scanned by an initial sensor (10), comprising: inverting the printing medium (3), scanning the register mark (1) on the first form side (4) is scanned, and using the register mark (1) on the first form side, ascertaining whether the reverse side (5) is in register.

2. Process according to claim 1, wherein the register mark (1) on the first form side (4) is scanned by a second sensor (11), which is mounted on the other side of the printing medium (3) in relation to the initial sensor (10).

3. Process according to claim 1, wherein the register mark (1) on the first for side (4) is scanned by the initial sensor (10) through the printing material.

4. Process according to claim 1, wherein the position of the register mark (1) in relation to the printing medium (3) is scanned.

5. Process according to claim 1, wherein the position of the printing medium (3) in relation to the conveyor belt (6) is scanned.

6. Mechanism to scan at least one register mark (1) on a printing medium (3) in a printing machine, with at least one register mark (1) on the first form side (4), comprising: an initial sensor (10) to scan the register mark (1) on the first form side (4) before the printing medium (3) is inverted, and to scan the register mark (1) through the printing medium (3) after the printing medium (3) has been inverted.

7. Mechanism according to claim 6, wherein a second sensor (11) to scan the register mark (1) through a conveyor belt (6) that is conveying the printing medium (3) after the printing medium (3) has been inverted, whereby the second sensor (11) is mounted on the other side of the printing medium (3) in relation to the initial sensor (10).

8. Mechanism according to claim 7, wherein the register mark (1) has a triangular shape and the shift in position of the printing medium (3) at right angles to the direction of travel of the printing medium (3) can be scanned.
